(19) United States
(12) Patent Application Publication
(10) Pub. No.: US 2013/0329693 A1
(43) Pub. Date: Dec. 12, 2013

(54) Channel Switching to a White Space Band Through TDLS

(71) Applicants: Jihyun Lee, Anyang-si (KR); Eunsun Kim, Anyang-si (KR); Yongho Seok, Anyang-si (KR)

(72) Inventors: Jihyun Lee, Anyang-si (KR); Eunsun Kim, Anyang-si (KR); Yongho Seok, Anyang-si (KR)

(21) Appl. No.: 14/001,529

(22) PCT Filed: Dec. 7, 2011
(86) PCT No.: PCT/KR2011/009422

§ 371 Date: Aug. 26, 2013

Related U.S. Application Data
(60) Provisional application No. 61/446,510, filed on Feb. 25, 2011.
(60) Provisional application No. 61/474,740, filed on Apr. 12, 2011.

(51) Int. Cl. H04W 76/02

(52) U.S. Cl. CPC H04W 76/023
USPC 370/329

(57) ABSTRACT

When channel switching to a channel in a white space band is performed through tunneled direct link setup (TDLS) in a wireless local area network (WLAN) system, it is confirmed whether or not a white space band between STAs is operable by directly including white space band performance between communication target STAs and device identifier information in a TDLS request/response message. Thus, one STA performs a channel availability query (CAQ) procedure in order to obtain available channel information, and a TDLS channel switching request/response message is exchanged by selecting a target channel in an available channel. Therefore, TDLS-based channel switching to a white space band is efficiently performed.

### TECHNICAL FIELD

The disclosure relates to a method of performing channel switching to a channel in a White Space band through Tunneled Direct Link Setup (TDLS) in a wireless local area network (WLAN) system and an apparatus for the same.

### BACKGROUND ART

Standards for WLAN technologies have been developed as Institute of Electrical and Electronics Engineers (IEEE) 802.11 standards. IEEE 802.11a and 802.11b use an unlicensed band at 2.4 GHz or 5 GHz. IEEE 802.11b provides a transfer rate of 11 Mbps and IEEE 802.11a provides a transfer rate of 54 Mbps. IEEE 802.11g provides a transfer rate of 54 Mbps using Orthogonal frequency division multiplexing (OFDM) at 2.4 GHz. IEEE 802.11n provides a transfer rate of 300 Mbps for 4 spatial streams using multiple input multiple output-OFDM (MIMO-OFDM). IEEE 802.11n supports a channel bandwidth of up to 40 MHz and, in this case, provides a transfer rate of 600 Mbps.

An IEEE 802.11af standard for defining operations of unlicensed devices in a TV whitespace (TVWS) band is currently under development.

Hereinafter, Tunneled Direct Link Setup (TDLS) used in a WLAN system will be described.

FIG. 1 is a view illustrating a basic concept of TDLS.

As shown in FIG. 1, an Access Point (AP) may provide a service to a plurality of stations (STAs) in a WLAN system. FIG. 1 shows a structure in which two STAs (first STA 200 and second STA 300) are connected to one AP 100 as an example.

TDLS means channel setup for direct communication between the first STA 200 and the second STA 300 not via the AP. To this end, setup messages are encapsulated in a data frame to set direct link between the STAs without participation of the AP. Consequently, the AP does not require a capacity for direct link setup. In addition, the AP does not require a capacity used for direct link between the STAs to perform TDLS.

For TDLS, one STA (for example, the first STA 200) may transmit a TDLS request message on a base channel and another STA (for example, the second STA 300) may transmit a TDLS response message on a base channel to confirm TDLS support capabilities of both the STAs. In the above example, the first STA 200 may transmit a TDLS confirm message to complete TDLS.

After TDLS is completed, one STA (for example, the first STA 200) may transmit a channel switch request message on a target channel and may perform TDLS-based direct communication on the target channel according to reception of a response message thereto.

In a case in which channel switching to a White Space band is performed using TDLS, however, the TDLS-based channel switching scheme cannot be used without change due to characteristics of the White Space band.

### DISCLOSURE

### Technical Problem

In order to solve the above problem, the disclosure provides a method of performing channel switching to a channel in a White Space band through Tunneled Direct Link Setup (TDLS) and an apparatus for the same.

### Technical Solution

In accordance with an aspect of the present invention, the above object may be accomplished by the provision of a method of performing channel switching, by a first station (STA), to a channel in a white space band through Tunneled Direct Link Setup (TDLS) with a second station, the method comprising exchanging a TDLS request message and a TDLS response message with the second station through an Access Point (AP) associated with the first station and the second station in a first frequency band, the TDLS request message or the TDLS response message comprising white space band device capacity information and a device identifier of the second station, acquiring available channel information in the white space band through the AP when the device capacity information and the device identifier of the second station indicate that operation of the second station in the white space band is allowed, and exchanging a TDLS channel switch request message and a TDLS channel switch response message for TDLS channel switching to a target channel selected from the available channels with the second station directly when one or more available channels are present, the TDLS channel switch request message or the TDLS channel switch response message comprises the available channel information.

the available channel information and transmit power limitation information on the available channels may be acquired through the AP when the device capacity information and the device identifier of the second station indicate that operation of the second station in the white space band is allowed, the TDLS channel switch request message and the TDLS channel switch response message for TDLS channel switching to the target channel may be directly exchanged with the second station, and the TDLS channel switch request message or the TDLS channel switch response message may comprise the available channel information and the transmit power limitation information on the available channels.

The device capacity information of the second station may indicate a geo-location information acquisition capability, a white space band database access capability, and a channel availability query capability in the white space band of the second station.

The step of exchanging the TDLS channel switch request message or the TDLS channel switch response message comprising the available channel information may further comprises exchanging an enabling signal.

The device identifier of the second station may comprise an FCC identifier and, the FCC identifier may determine that the device identifier supports the white space band when the FCC identifier indicates that operation of the second station in the white space band is allowed.

At least one of the first station and the second station may have the white space band database access capability when the AP does not have a function of operation in the white space band. On the other hand, at least one of the first station and the second station may not have the white space band database access capability when the AP has a white space band database access capability. In this case, the first station may acquire the available channel information in the white space band acquired by the AP through channel availability query.

In accordance with another aspect of the present invention, the above object may be accomplished by the provision of a first station (STA) configured to perform channel switching to a channel in a white space band through Tunneled Direct Link Setup (TDLS) with a second station, the first station comprising a transceiver to exchange a TDLS request message and a TDLS response message with the second station through an AP associated with the first station and the second station in a first frequency band and to directly exchange a TDLS channel switch request message and a TDLS channel switch response message for TDLS channel switching to a target channel in the white space band with the second station and a processor functionally connected to the transceiver to control channel switching to the target channel through TDLS with the second station, wherein the TDLS request message or the TDLS response message comprises white space band device capacity information and a device identifier of the second station, the processor controls the second station to acquire available channel information in the white space band through the AP when the device capacity information and the device identifier of the second station indicate that operation of the second station in the white space band is allowed, the TDLS channel switch request message or the TDLS channel switch response message comprises the available channel information, and the target channel is selected from among the available channels.

### Advantageous Effects

According to the embodiments of the present invention as described above, it is possible to efficiently perform channel switching even in a case in which a switching target channel is a channel in a white space band in TDLS-based channel switching, thereby achieving direct link communication in the white space band.

### DESCRIPTION OF DRAWINGS

FIG. 1 is a view illustrating a basic concept of TDLS.

FIGS. 2 to 10 are views illustrating TDLS-based channel switching to a white space band according to an embodiment of the present invention.

FIGS. 11 and 12 are views illustrating TDLS-based channel switching to a white space band according to another embodiment of the present invention.

FIG. 13 is a block diagram showing construction of an STA that can implement the present invention.

### BEST MODE

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the invention. The same reference numbers will be used throughout this specification to refer to the same or like parts.

Hereinafter, a description will be given of a method of performing channel switching to a channel in a white space band through TDLS and an apparatus for the same. That is, the present invention relates to a channel switching mechanism for using a channel in a white space band as an off channel in direct link transmission.

STAs may perform channel switching in direct link transmission. An off channel mechanism in IEEE 802.11z Tunneled Direct Link Setup (TDLS) may be given as an example. In the off channel mechanism, movement to another channel that is not used by an AP is performed for direct link transmission between the STAs.

To this end, the STAs may negotiate a target channel through a channel switch request frame and a channel switch response frame and perform movement. In addition, in a case in which one STA functions as an AP for another STA, channel switching may be performed. Wi-Fi Direct proposed by the Wi-Fi Alliance Peer-to-Peer (P2P) Group may be given as an example. In Wi-Fi Direct, one STA may be connected to a client of an AP and, at the same time, may function as an AP for other STAs. At this time, the STA may function as an AP for STAs corresponding to clients thereof on another channel different from the channel on which the STA is connected to the client of the AP.

For direct link operation, the STAs may transmit Tunneled Direct Link Setup Request (TDLS Request), Tunneled Direct Link Setup Response (TDLS Response), and Tunneled Direct Link Setup Confirm (TDLS Confirm) management action frames in a state of being encapsulated in data frames. A TDLS request message and a TDLS Response message may include a capacity of the STAs. However, the capacity of the STAs is different from a capacity of a device operating in a white space band, which will hereinafter be described.

Once TDLS is successfully performed, transmission on a base channel through direct link between peer STAs is possible. The base channel is an operating channel, which may have a bandwidth of 2.4 GHz or 5 GHz.

In channel switching to a white space band after TDLS is performed as described above, however, there are points to be duly considered. First, characteristics of a white space band (for example, a TVWS band) different from a general WLAN system band will be described and then a method of changing the above-described TDLS channel switching procedure in consideration of such characteristics of the TVWS band will be described.

The TVWS band, which is an example of the white space band, includes a band having frequencies allocated to a broadcast TV, such as an Ultra High Frequency (UHF) band and a very high frequency (VHF) band. The TVWS band means a frequency band in which use of an unlicensed device is allowed under a condition that communication of a licensed device operating in the corresponding frequency bands is not obstructed. The licensed device may include a TV and a wireless microphone. The licensed device may be referred to as an incumbent user or a primary user.

In a 512 to 608 MHz band and a 614 to 698 MHz band, operation of all unlicensed device is allowed except in some special instances. In a 54 to 60 MHz band, a 76 to 88 MHz band, a 174 to 216 MHz band, and a 470 to 512 MHz band, on the other hand, only communication between fixed devices is allowed. The fixed devices are devices that transmit signals only at fixed locations. An IEEE 802.11 TVWS terminal is an unlicensed device operating using an IEEE 802.11 media access control (MAC) layer and a physical layer (PHY) in a TVWS spectrum.

In order to use TVWS, an unlicensed device must provide a protection function to a licensed device. Before starting signal transmission in TVWS, therefore, the unlicensed device must confirm whether the licensed device occupies a corresponding band.

To this end, the unlicensed device may access a geo-location database via the Internet or a dedicated network to acquire information regarding a channel list available in a corresponding area. The geo-location database is a database to store and manage information of registered licensed devices, geo-location of the licensed devices, and channel use information dynamically changed according to channel use time.

Alternatively, the unlicensed device may perform spectrum sensing or measurement to confirm whether a corresponding band is occupied by a licensed device. An energy detection scheme, a feature detection scheme, etc. may be used as the spectrum sensing mechanism. In a case in which the intensity of a signal received on a specific channel exceeds a predetermined value or a DTV preamble is detected, it is possible to determine that the specific channel is being used by a licensed device. In a case in which it is determined that a channel adjacent to a currently used channel is used by a licensed device, the unlicensed device needs to decrease transmit power. Specifically, according to FCC regulations, the allowable maximum transmit power on an available channel is 100 mW. In a case in which an adjacent channel is used by a primary user, use of the corresponding channel may be restricted or allowable power may be limited to 40 mW according to device type.

Meanwhile, the unlicensed devices operating in the white space band as described above may be mainly divided into (1) a fixed device and (2) a personal/portable device. The personal/portable device may operate as (a) a mode 2 device depending on access to a geo-location database to decide a channel available at a location thereof and (b) a mode 1 device operating only on a channel indicated by the fixed device or the mode 2 personal/portable device (see FCC regulations). In addition, according to FCC regulations, the mode 1 personal/portable device may operate in a white space band only in a case in which it is certified that an FCC identifier of a corresponding device is allowed to operate in a corresponding band.

Due to the characteristics of the white space band as described above, TDLS switching to the white space band is not prescribed in the current standards.

Hereinafter, a description will be given of a TDLS-based channel switching method according to the characteristics of the white space band as described above and capacities of devices that can operate in the white space band.

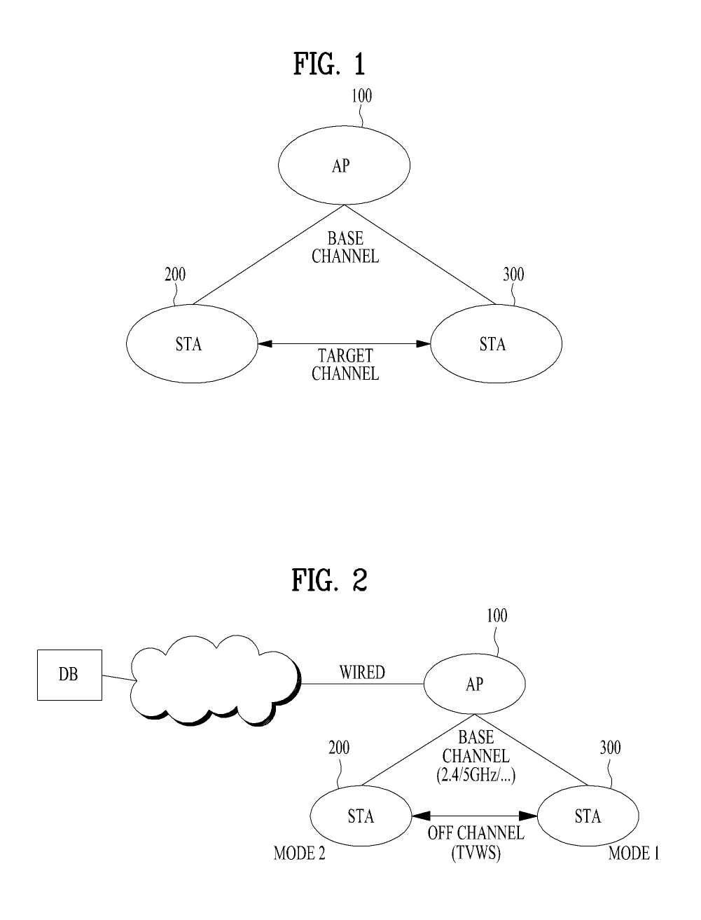

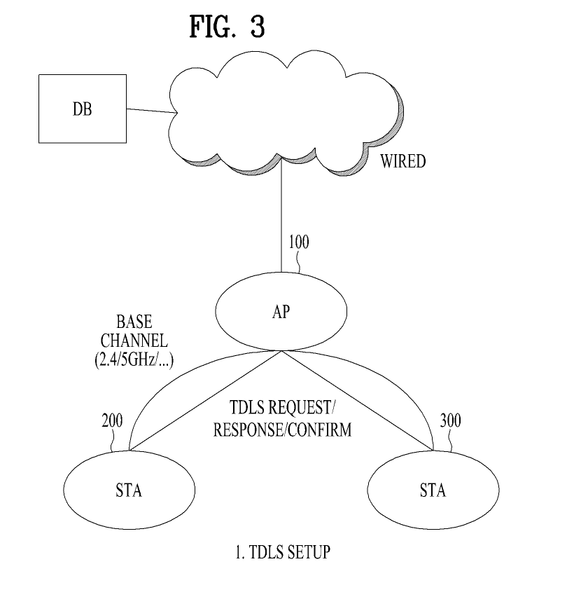

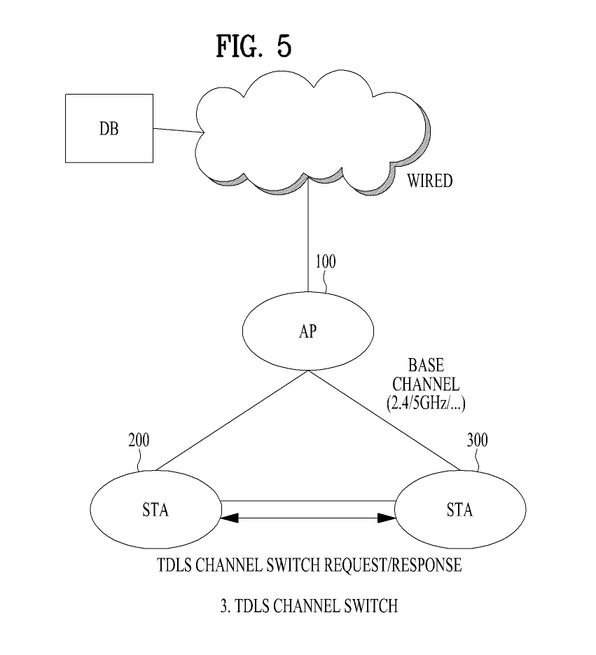

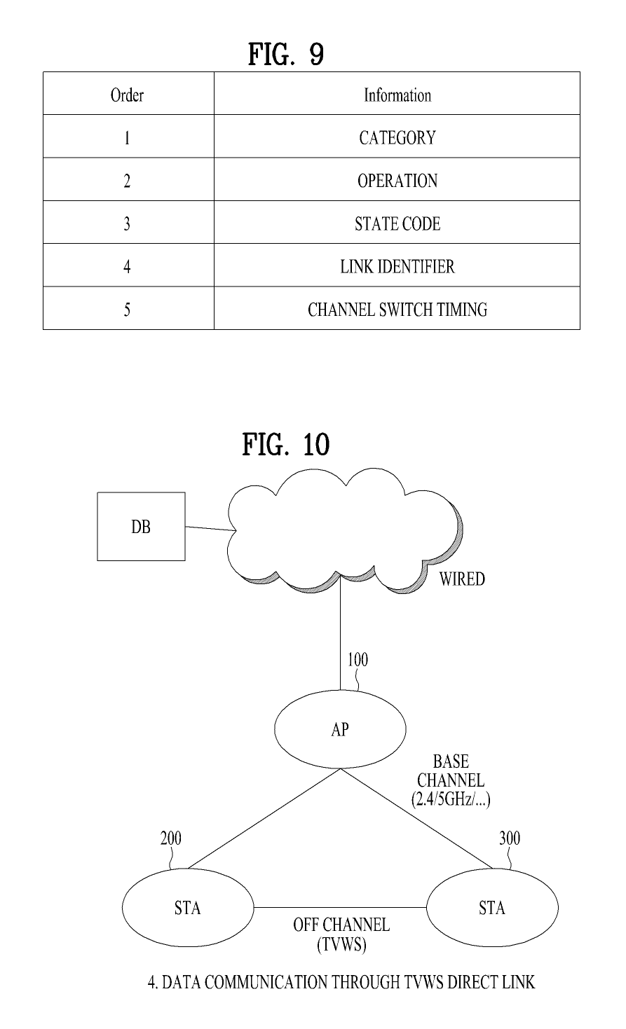

FIGS. 2 to 10 are views illustrating TDLS-based channel switching to a white space band according to an embodiment of the present invention.

First, even in this embodiment, it is assumed that a first STA 200 and a second STA 300 are connected to an AP 100 in the same manner as in FIG. 1. In this embodiment, it is assumed that the first STA 200 and the second STA 300 perform TDLS-based channel switching to a white space band while the first STA 200 and the second STA 300 operate on a base channel having a bandwidth of 2.4 GHz or 5 GHz with the AP 100. The AP may be connected to a DB in a corresponding white space band (for example, a TVWS band) via a wired network.

As a precondition for performing TDLS-based channel switching to a white space band, it is required for both the STAs 200 and 300 to have an operating capacity in the white space band. In addition, in this embodiment, it is assumed that the AP 200 does not have an operating capacity in the white space band. In this case, at least one selected from between the first STA 200 and the second STA 300 may be a mode 2 device (or a fixed device) having a geo-location database access capacity. FIG. 2 shows a case in which the first STA 200 is a mode 2 personal/portable device.

In this embodiment, as shown in FIG. 3, in order to perform TDLS-based channel switching to the white space band, first, the first STA 200 may transmit a TDLS request message to the second STA 300 and receive a TDLS response message as a response thereto. Of course, the other device may transmit the TDLS request message and receive the TDLS response message.

In this embodiment, device capacity information and device identifier information for operation in the white space band may be included in the TDLS request message and the TDLS response message. The device capacity information for operation in the white space band may have the following formats.

TABLE 1

| | | | Channel | |
|---|---|---|---|---|
| | Geo-location | Database | availability | |
| | capacity | access capacity | query capacity | |
| Octet | 1 | 1 | 1 | |
| Value | 1 | 1 | 1 | Fixed/Mode II |
| | 1 | 0 | 1 | Mode I |
| | 0 | 1 | 1 | Mode I |
| | 0 | 0 | 1 | Mode I |

That is, the device capacity information for operation in the white space band may include a geo-location capacity (ability to acquire geo-location information), a database access capacity, and a channel availability query capacity. It can be seen that the first STA 200 and the second STA 300 are fixed/mode 2 devices or mode 1 devices based on the information. Table 1 is illustrative. In the present invention, therefore, the device capacity information may be changed so long as it is possible to determine whether a corresponding device is a fixed/mode 2 device or a mode 1 device based on the device capacity information for operation in the white space band included in the TDLS request message and the TDLS response message. On the other hand, the device identifier information includes information for determining whether a corresponding device is a device certified for operation in the white space band. For example, an FCC identifier may be included (an FCC identifier of a 14 octet length). Consequently, the STAs successfully performed TDLS according to this embodiment may acquire a device capacity and device identifier thereof. In a case in which a TDLS confirm message to reception (transmission) of the TDLS request message and transmission (reception) of the TDLS response message is received (transmitted), TDLS is successfully completed. Afterwards, direct link communication on the base channel is possible.

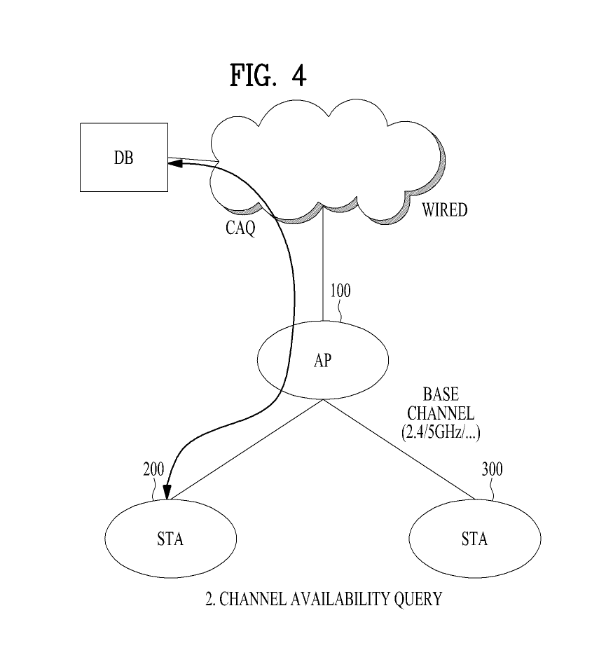

Subsequently, as shown in FIG. 4, the STAs according to this embodiment may perform a Channel Availability Query (CAQ) procedure to acquire information regarding available channels that can operate in the white space band prior to channel switching. One selected from an available channel list acquired at a corresponding location through the CAQ procedure may be used as a target channel to perform a subsequent channel switching procedure.

In this embodiment, it is assumed that the AP does not have an operating capacity in the white space band and that the first STA 200 is a mode 2 device having a database access capacity. Consequently, the first STA 200 may access a corresponding white space band DB through the AP 100 to acquire available channel information at a location thereof. In addition, in one exemplary embodiment of the present invention, it is possible to further acquire transmit power limitation information on corresponding available channels in addition to the available channel information.

In addition, the first STA 200, which is a mode 2 device according to this embodiment, may confirm whether the second STA 300 is a device that can operate in a corresponding white space band using a received identifier of the second STA 300.

In a case in which at least one available channel is present and an identifier of the other STA is verified through the CAQ procedure as described above, the first STA 200 may perform TDLS channel switching to the available channel with the second STA 300.

In this embodiment, the available channel information and the transmit power limitation information acquired by the first STA 200 as described above may be transmitted to the second STA 300 in a state of being included in a TDLS channel switch request message. Consequently, the first STA 200 and the second STA 300, which will perform TDLS-based channel switching, may share the available channel information and the transmit power limitation information. In addition, the first STA 200 according to this embodiment may transmit an enabling signal to enable the white space band of the second STA 300. An enabling signal is a signal that an enabling STA having a database access capacity in a white space band transmits to enable operation of a subordinate STA in the white space band. In this embodiment, the enabling signal may be transmitted in a state of being included in a TDLS channel switch request/response message or separately, which will hereinafter be described.

FIG. 6 shows an example of a TDLS channel switch request message according to an embodiment of the present invention.

In the TDLS channel switch request message shown in FIG. 6, a target channel field may be any one of the available channels acquired through the CAQ procedure previously described with reference to FIG. 4. A “Regulatory Class” field may indicate a corresponding white space band (for example, a TVWS band). In addition, a “power limitation” field may indicate transmit power limitation information on a corresponding available channel and an “available channel information” field may indicate available channel information. For example, available channels may be received in the form of a White Space Map.

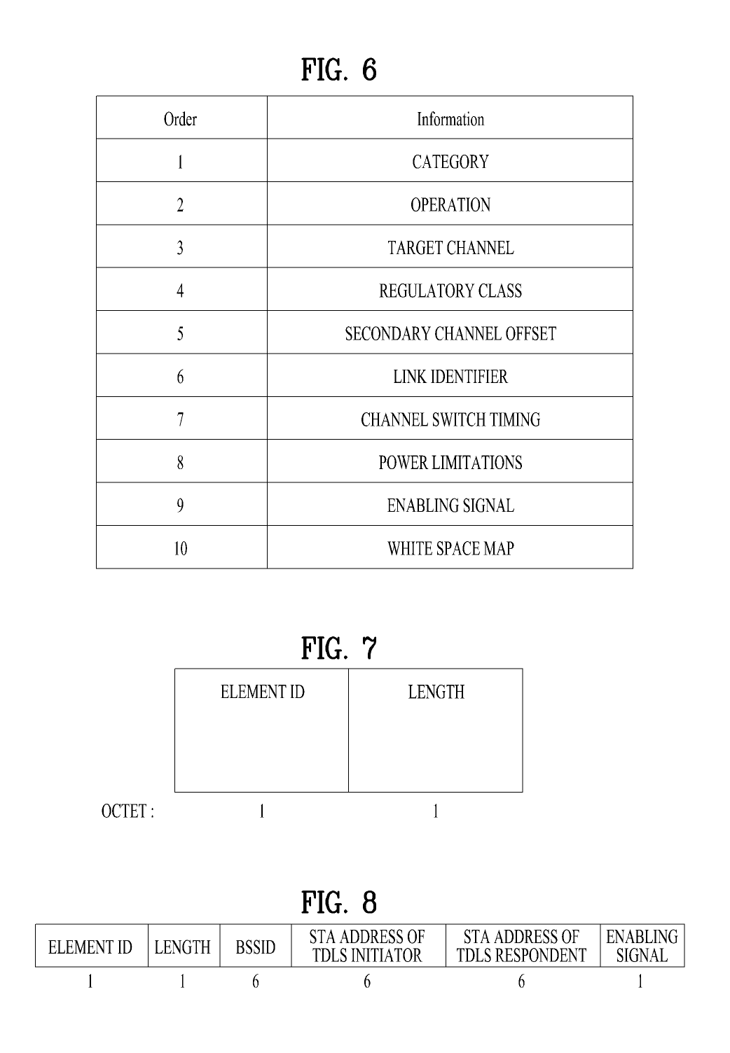

In addition, in one embodiment of the present invention, as shown in FIG. 6, the TDLS channel switch request message may be transmitted in a state in which an enabling signal is included in the TDLS channel switch request message. For example, as shown in FIG. 7, an enabling signal may be added to a TDLS channel switch request/response message in the form of a new Information Element. Alternatively, as shown in FIG. 8, an enabling signal may be added in the form of a new field of an existing Link identifier element. In a case in which the enabling signal is added in the form of a new field of the link identifier element as shown in FIG. 8, if an “enabling signal” field is set to 1, the corresponding signal may indicate a signal to allow enabling.

Through the procedures as described above, the first STA 200 and the second STA 300 may perform direct data communication on a target channel, which is an available channel in the white space band as shown in FIG. 10.

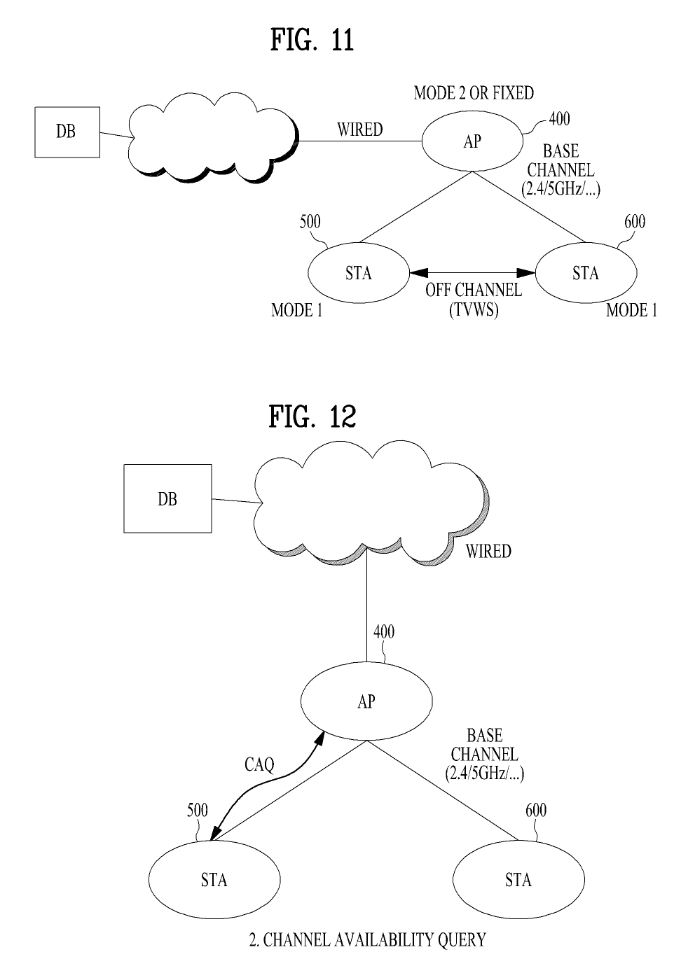

FIGS. 11 and 12 are views illustrating TDLS-based channel switching to a white space band according to another embodiment of the present invention.

In the embodiment shown in FIG. 11, it is assumed that an AP 400 is a mode 2 device or a fixed device having a database access capacity in a white space band unlike FIG. 2. In a case in which the AP 400 is a mode 2 device or a fixed device having a database access capacity as described above, TDLS-based channel switching to the white space band according to the present invention may be performed even when both a first STA 500 and a second STA 600 are mode 1 devices which do not have a database access capacity.

Specifically, FIG. 12 shows that the first STA 500 performs CAQ to the AP 400 having a database access capacity. The AP 400, receiving a CAQ request message from the first STA 500, may access a database to acquire available channel information and power limitation information and provide the acquired information to the first STA 500. The available channel information and the power limitation information acquired as described above may be used in the same manner as in the previous embodiment.

The above embodiments of the present invention will be summarized as follows.

In order for Peer STAs to operate in a white space band (for example, a TVWS band), protection of a primary user must be considered. In order to change a direct link operation channel between the Peer STAs to a white space channel, therefore, at least one STA must access a white space database to register location information thereof and to acquire a white space band channel list. In a case in which an AP does not have a database access capacity, at least one STA must function as a mode 2 personal/portable STA. In a case in which the AP is a mode 2 or fixed device as described above, however, the Peer STAs may be mode 1 personal/portable STAs.

In a case in which TDLS is completed and the STAs, which will perform direct connection, are allowed to operate in the white space, the mode 2 STA accesses the database through the AP, to which the mode 2 STA is connected. A procedure of acquiring an available channel list as described above is a channel availability query (CAQ) procedure. If the location of the STA is changed by a specific distance of more (for example, 100 m or more) or previously acquired database information is no longer valid, the STA may return to a base channel and perform a query procedure again. In addition, in a case in which the AP is a mode 2/fixed device as described above, the STA may perform a CAQ procedure to the AP.

The STA, acquiring the white space channel information, may select a target channel, which the STA will move to, from available white space channels.

First, a case in which an AP does not operate in a white space band will be summarized as follows.

Generally, in order for a mode 1 device to operate in a white space, a mode 2 device must receive verification as to whether an identifier of the mode 1 device is valid from a database and the mode 1 device must acquire available channel information from the mode 2 device. For contact initiation with a fixed or mode 2 device, however, the mode 1 device may transmit a signal on an operating channel of the mode 2 device or a channel, the use of which is allowed by the mode 2 device.

When TDLS is completed, therefore, STAs having a geo-location database access capacity may operate as mode 2 STAs and access a database to acquire information regarding channels available at a geo-location thereof and to decide an operating channel from the acquired channel list. In addition, the STAs operating as the mode 2 STAs may confirm whether device identifiers of Peer STAs are valid from the database.

In a case in which one or more available channels acquired by the mode 2 STAs is present and it is confirmed that the device identifiers of the Peer STAs acquired during the TDLS procedure are valid, the mode 2 STAs may select one from among the available channels to initiate TDLS channel switching. For TDLS channel switch, the STAs may transmit or receive a TDLS channel switch Request and a TDLS channel switch Response in direct link on the base channel.

When performing channel switching to a white space channel, the STA having a device capacity as mode 2 must transmit an available channel list to the STA having a device capacity as mode 1, i.e. the peer STA. This is because the peer STA operating as the mode 1 device must acquire available channels from the mode 2 device according to regulations to perform transmission in the white space channel. When the mode 2 STA transmits a channel switch request action management frame to the peer STA, therefore, the mode 2 STA may transmit the channel switch request action management frame in a state of including available channel information (for example, a white space map element).

When performing channel switching to the white space channel, available power may be different from that on the base channel. This is because the maximum transmit power defined in the regulations for protection of a primary user may be changed depending upon device type of the primary user and the STA. For example, if the STA operating at 100 mW on the base channel moves to a channel adjacent to a TV channel, the maximum transmit power is limited to 40 mW.

In channel switching, therefore, the STA needs to inform limitations on transmit power on a target channel after the STA selects the target channel. To this end, when the STA transmits a channel switch request management frame to the peer STA, the STA may transmit the channel switch request management frame in a state of including a power limitation information element. In addition, when the peer STA responds to the channel switch request management frame, the peer STA may respond to the channel switch request management frame in a state of including power limitation information element. In a case in which the STAs transmit different power limitation information elements, the maximum transmit power on the target channel may be set to a lower one of the different power limitation values.

Meanwhile, the mode 1 STA may transmit a TDLS Channel Switch Request to the mode 2 peer STA in direct link on the base channel to initiate channel switching. Before switching request, however, the mode 1 STA must perform channel availability query to the mode 2 peer STA. The mode 2 peer STA may confirm whether a device identifier of the mode 1 STA is valid and, upon confirming that the device identifier of the mode 1 STA is valid, may transmit available channels. At this time, the TDLS Channel Switch Request does not include an enabling signal. The mode 2 peer STA, receiving the TDLS Channel Switch Request, responds to the TDLS Channel Switch Request as a TDLS Channel Switch Response. At this time, an enabling signal is included.

The mode 1 STA may transmit a TDLS Channel Triggering frame to the peer STA having a geo-location database access capacity to request initiation of a channel switching procedure. The STA, receiving the TDLS Channel Triggering frame, functions as a mode 2 device, accesses the database to acquire available channels and confirms validity of the device identifier of the peer STA acquired during the TDLS procedure. In a case in which one or more acquired available channels are present and it is confirmed that the device identifier of the peer STA acquired during the TDLS procedure is valid, the STA may select one from among the available channels to initiate TDLS channel switching.

In a case in which a device identifier must be securely transmitted, the device identifier cannot be transmitted during the TDLS procedure. When performing channel switching to the white space channel, therefore, the mode 2 device must acquire the device identifier of the peer mode 1 STA before channel switching. Consequently, the mode 1 device may transmit the device identifier to the mode 2 peer STA during the channel availability query procedure or the mode 2 STA may directly request the device identifier from the peer STA.

The TDLS Channel Switch Request may not include an enabling signal. In this case, regulations may be prescribed such that the mode 1 STA recognizes the TDLS Channel Switch Request including available channel information (white space map) transmitted by the mode 2 STA as an enabling signal to allow transmission in the white space.

The TDLS Channel Switch Request may not include available channel information (white space map). For example, in a case in which the mode 1 STA acquires available channel information (white space map) through channel availability query before channel switching, the TDLS Channel Switch Request may not include the available channel information (white space map). Alternatively, the mode 2 STA may transmit only an enabling signal to the mode 1 STA while informing of a target channel. After movement to the corresponding target channel, the mode 1 STA may receive available channel information (white space map) from the mode 2 STA on the channel to which movement has been performed. Alternatively, the mode 1 STA may request available channel information (white space map) from the mode 2 STA on the channel to which movement has been performed.

In a case in which the TDLS Channel Switch Request does not include available channel information (white space map), device identifier verification may be performed even after movement to the channel. In a case in which the device identifier of the mode 1 STA is not valid, the mode 1 STA request of the available channel information (white space map) is rejected. The mode 2 STA may also not transmit the available channel information (white space map). As long as it is possible to acquire the device identifier before channel switching, however, verification of the corresponding ID may be performed before channel switching.

The peer STA operating in the white space band direct link may perform channel switching to a 2.4 GHz/5 GHz band. In this case, the capacity or device type of the STA transmitting TDLS Channel Switch Request is not particularly restricted.

The TDLS Channel Switch Request may not include available channel information (white space map) and an enabling signal. In this case, the mode 2 STA may inform the mode 1 STA of a target channel and transmit power only. The mode 1 STA, having moved to the target channel, is on standby on the channel to which movement has been performed. The mode 2 STA may transmit an enabling signal and available channel information (white space map) on the channel to which movement has been performed or may transmit an enabling signal on the channel to which movement has been performed to allow communication with the mode 1 STA such that the mode 1 STA acquires available channel information (white space map). Alternatively, regulations may be prescribed such that in a case in which the TDLS Channel Switch Request transmitted by the mode 2 STA sets the target channel as a white space channel, the mode 1 STA recognizes it as an enabling signal to allow transmission in the while space band.

In a case in which the TDLS Channel Switch Request does not include available channel information (white space map) and an enabling signal, device identifier verification may be performed when the mode 1 STA receives an enabling signal after movement to the channel. In a case in which the device identifier of the mode 1 STA is not valid, the mode 1 STA request of the available channel information (white space map) is rejected. The mode 2 STA may also not transmit the available channel information (white space map). As long as it is possible to acquire the device identifier before channel switching, however, verification of the corresponding device identifier may be performed before channel switching.

In a case in which the AP is a fixed/mode 2 device, the mode 1 STA may perform CAQ to the AP to acquire available channel information (white space map).

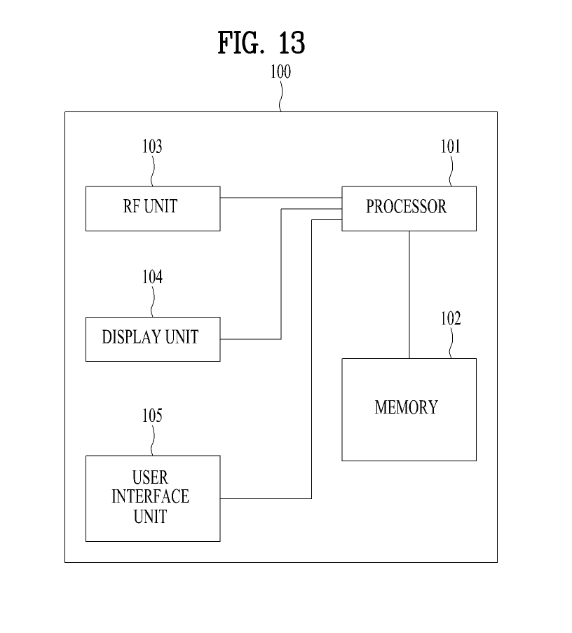

FIG. 13 is a block diagram showing construction of an STA that can implement the present invention.

As shown in FIG. 13, an STA 100 may include a processor 101, a memory 102, a radio frequency (RF) unit 103, a display unit 104, and a user interface unit 105.

A function of a physical interface protocol layer is performed by the processor 101. The processor 101 provides a control plane and a user plane. A function of each layer may be performed by the processor 101.

The memory 102 is electrically connected to the processor 101 to store an operating system, applications, and general files.

In a case in which the device 600 is a user device, the display unit 104 may display a variety of information. As the display unit 104, a well-known device such as a Liquid Crystal Display (LCD) or an Organic Light Emitting Diode (OLED) may be used. The user interface unit 105 may be coupled to a well-known user interface such as a keypad or a touchscreen.

The RF unit 103 is electrically/functionally connected to the processor 101 to transmit or receive a radio signal. The RF unit 103 may include a transmission module and a reception module. In addition, the RF unit 103 may be referred to as a transceiver.

The transmission module may perform predetermined coding and modulation with respect to a signal and/or data to be scheduled from the processor 101 and to be transmitted to the outside and transmit the coded and modulated signal and/or data to an antenna.

The reception module may perform decoding and demodulation with respect to a radio signal received from the outside through an antenna to restore the radio signal in the form of original data and transmit the restored radio signal to the processor 101.

The transceiver of the first STA 100 according to this embodiment may exchange a TDLS request message and a TDLS response message with the second STA on a basic frequency band through the AP associated with the first STA and the second STA. In addition, the transceiver may directly exchange a TDLS channel switch request message and a TDLS channel switch response message for TDLS channel switching to a target channel in a white space band with the second STA.

At this time, the TDLS request message or the TDLS response message may include device capacity information and a device identifier of the second STA in the white space band. In a case in which the device capacity information and the device identifier of the second STA support the white space band, the processor 101 may control the second STA to acquire available channel information in the white space band through the AP.

In addition, the TDLS channel switch request message or the TDLS channel switch response message may include the available channel information and one of the available channels may be selected as the target channel.

The detailed description of the preferred embodiments of the present invention has been given to enable those skilled in the art to implement and practice the invention. Although the invention has been described with reference to the preferred embodiments, those skilled in the art will appreciate that various modifications and variations can be made in the present invention without departing from the spirit or scope of the invention described in the appended claims. For example, an embodiment of the present invention may be constructed by combining components or configurations of the above-described embodiments of the present invention. Accordingly, the invention should not be limited to the specific embodiments described herein, but should be accorded the broadest scope consistent with the principles and novel features disclosed herein.

### INDUSTRIAL APPLICABILITY

While various embodiments of the present invention as described above are applied to IEEE 802.11 systems, the embodiments of the present invention can be equally applied to various mobile communication systems in which unlicensed devices can perform TDLS-based channel switching to a white space band.

1. A method of performing channel switching, by a first station (STA), to a channel in a white space band through Tunneled Direct Link Setup (TDLS) with a second station, the method comprising:
transmitting a TDLS request message to the second station through an Access Point (AP) associated with the first station and the second station in a first frequency band,
receiving a TDLS response message from the second station through the AP, wherein the TDLS response message comprises white space band device capacity information of the second station and a device identifier of the second station;
acquiring available channel information in the white space band through the AP, when operation of the second station in the white space band is allowed based on the device capacity information of the second station and the device identifier of the second station;
transmitting, directly to the second station, a TDLS channel switch request message for TDLS channel switching to a target channel selected from the available channels and a when one or more available channels are present, wherein the TDLS channel switch request message comprises the available channel information; and
receiving directly a TDLS channel switch response message from the second station.

2. The method according to claim 1,
wherein transmit power limitation information on the available channels is acquired through the AP when acquiring the available channel information, when operation of the second station in the white space band is allowed based on the device capacity information of the second station and the device identifier of the second station; and
wherein the TDLS channel switch request message further comprising the transmit power limitation information on the available channels.

3. The method according to claim 1, wherein the device capacity information of the second station indicates a geo-location information acquisition capability, a white space band database access capability, and a channel availability query capability in the white space band of the second station.

4. The method according to claim 1, wherein the step of transmitting the TDLS channel switch request message further comprises transmitting an enabling signal.

5. The method according to claim 1, wherein the device identifier of the second station comprises an FCC identifier, the FCC identifier indicates that operation of the second station in the white space band is allowed.

6. The method according to claim 1, wherein the AP does not have a function of operation in the white space band, and
at least one of the first station and the second station has a white space band database access capability.

7. The method according to claim 1, wherein the AP has a white space band database access capability, and
the first station acquires the available channel information in the white space band acquired by the AP through channel availability query.

8. A first station (STA) configured to perform channel switching to a channel in a white space band through Tunneled Direct Link Setup (TDLS) with a second station, the first station comprising:
a transceiver to transmit a TDLS request message to the second station and receive a TDLS response message from the second station through an AP associated with the first station and the second station in a first frequency band and to directly transmit a TDLS channel switch request message to the second station and receive a TDLS channel switch response message for TDLS channel switching to a target channel in the white space band from the second station; and
a processor functionally connected to the transceiver to control channel switching to the target channel through TDLS with the second station,
wherein the TDLS response message comprises white space band device capacity information of the second station and a device identifier of the second station,
the processor controls the second station to acquire available channel information in the white space band through the AP, when operation of the second station in the white space band is allowed based on the device capacity information of the second station and the device identifier of the second station,
the TDLS channel switch request message comprises the available channel information, and
the target channel is selected from among the available channels.

9. The first station according to claim 8, wherein the processor controls the second station to acquire the available channel information and transmit power limitation information on the available channels through the AP when operation of the second station in the white space band is allowed based on the device capacity information of the second station and the device identifier of the second station, and
the TDLS channel switch request message comprises the transmit power limitation information on the available channels.

10. The first station according to claim 8, wherein the device capacity information of the second station indicates a geo-location information acquisition capability, a white space band database access capability, and a channel availability query capability in the white space band of the second station.

11. The first station according to claim 8, wherein transmitting of the TDLS channel switch request message comprising the available channel information further comprises transmitting an enabling signal.

12. The first station according to claim 8, wherein the device identifier of the second station comprises an FCC identifier, the FCC identifier indicates that operation of the second station in the white space band is allowed.

13. The first station according to claim 8, wherein the AP does not have a function of operation in the white space band, and
at least one of the first station and the second station has a white space band database access capability.

14. The first station according to claim 8, wherein the AP has a white space band database access capability, and
the first station acquires the available channel information in the white space band acquired by the AP through channel availability query.

15. The method according to claim 1, wherein the TDLS request message comprises white space band device capacity information of the first station and a device identifier of the first station.

16. The method according to claim 1, wherein the TDLS channel switch response message comprises the available channel information.

17. The first station according to claim 8, wherein the TDLS request message comprises white space band device capacity information of the first station and a device identifier of the first station.

18. The first station according to claim 8, wherein the TDLS channel switch response message comprises the available channel information.
